(19) United States
(12) Patent Application Publication
(10) Pub. No.: US 2006/0092816 A1
(43) Pub. Date: May 4, 2006

(54) Objective optical system and optical pick up apparatus

(75) Inventor: Tohru Kimura, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/260,244

(22) Filed: Oct. 28, 2005

(30) Foreign Application Priority Data
Nov. 1, 2004 (JP) 2004-318319

(51) Int. Cl. G11B 7/00

(52) U.S. Cl. 369/112.08; 369/112.23; 369/44.23

(57) ABSTRACT

An objective optical system for use in an optical pick up apparatus in which recording and/or reproducing information is conducted for a first optical disc equipped with a protective layer having a thickness tᵢ by using a first light flux having a first wavelength λ₁ emitted from a first light source and recording and/or reproducing information is conducted for a second optical disc equipped with a protective layer having thickness t₂ (t₂≧t₁) by using a second light flux having a second wavelength λ₂ (λ₂>λ₁) emitted from a second light source, comprising: an optical surface forming a first diffractive structure, wherein the first diffractive structure provides a diffractive operation for the second light flux and doesn't provide a diffractive operation for the first light flux, wherein the objective optical system satisfies the following formula (1):
0.9<WD₁/WD₂<1.1 (1)
where WD₁ represents a first working distance in recording and/or reproducing the information for the first optical disc and WD₂ represents a second working distance in recording and/or reproducing the information for the second optical disc.

### BACKGROUND OF THE INVENTION

1. Field of the Invention

The present invention relates to an objective optical system and an optical pick up apparatus.

2. Description of Related Art

In recent years, in an optical pick up apparatus, the shortening of the wavelength of a laser light source used as a light source for the reproduction of the information recorded on an optical disc or for the recording of the information to an optical disc has progressed. For example, a laser light source of a wavelength of 405 nm such as a blue-violet semiconductor laser and a blue-violet SHG laser performing a wavelength conversion of an infrared semiconductor laser using a second harmonic generation has been practically applied.

If these blue violet laser light sources are used, in the case where an object lens of the same numerical aperture (NA) as that of a digital versatile disk (hereinafter simply referred to as DVD) is used, it becomes possible to record 15-20 GB of information on an optical disc having a diameter of 12 cm (the optical disc of such a standard has been proposed as a HD DVD (hereinafter simply referred to as HD)). When the NA of an object lens is raised to 0.85, it becomes possible to record 23-27 GB of information on an optical disc having a diameter of 12 cm (the optical disc of such a standard has been proposed as a Blu-ray disk (hereinafter simply referred to as BD)). Hereinafter, in the present specification, the optical disc and the magneto-optical disc which use a blue violet laser light source are named generically “high density optical disc.”

Moreover, a blue-violet laser light flux used for the record/reproduction of a high density optical disc is called as a “blue”; a read laser light flux used for the record/reproduction of a DVD is called as a “red”; and an infrared laser light flux used for record/reproduction of a CD is called as an “infrared.”

If it is only possible to perform the suitable record/reproduction of information on such a type of high density optical disc, then it cannot say that the value as a product of an optical disc player/recorder is sufficient. If the reality that DVD's and compact disks (CD's) recording various kinds of information are on the market at the present time is reflected, then the ability of only the record/reproduction of information on the high density optical disc is not sufficient, and, for example, it brings about a rise of a commodity value as an optical disc player/recording for a high density optical disc to make it possible to perform the record/reproduction of information pertinently to a DVD or a CD which a user possesses similarly.

From such a background, it is desired that an optical pick up apparatus mounted on an optical disc player/recorder for a high density optical disc maintains the compatibility to any of the high density optical disc, the DVD and the CD while the high density optical disc has the performance capable of performing the pertinent record/reproduction of information. A compatible optical pick up apparatus capable of the record/reproduction of the existing DVD and CD as well as any of the high density optical discs is important, and, among them, one-lens system performing the compatibility with an objective optical system is the most ideal form.

However, there is one problem when the record and/or the reproduction of information is performed using the same objective optical system to the optical discs under such a plurality of kinds of specifications.

That is the differences of the thicknesses of the protective layers (also called as transparent substrates) among the respective optical discs. For example, when the record and/or the reproduction of information are performed at different wavelengths to two kinds of optical discs such as the DVD and CD, or the HD DVD and the CD, or three kinds of optical discs such as the HD DVD, the DVD and the CD, the protective layer protecting the information recording surface of each of the DVD and HD DVD is 0.6 mm, and the thickness of the protective layer protecting the information recording surface of the CD is 0.6 mm. Consequently, the working distance (hereinafter simply referred to as a WD) at the time of performing the record/reproduction of informational on each optical disc becomes longer at the time of using the DVD and HD DVD, and becomes shorter at the time of using the CD.

Similarly, when the record and/or the reproduction of information are performed using different wavelengths to the optical discs having three kinds of the thicknesses of the protective layers of the BD, the DVD and the CD, which thicknesses are different from each other, the thickness of the protective layer protecting the information recording surface of the BD is 0.1 mm. Consequently, the working distances become the longest at the time of using the BD, and next longest at the time of using the DVD, and finally the shortest at the time of using the CD.

Incidentally, in the present specification, the interval on an optical axis between the optical surface of an objective optical system positioned nearest to an optical disc and the surface of the optical disc in the state in which a laser light flux condensed by the objective optical system is focused on the information recording surface of the optical disc is called as a working distance at the time of using the optical disc.

Consequently, for example, in case of performing the record or the reproduction of information on a CD after performing the record or the reproduction of information on a BD, it is necessary to perform an operation of performing the variable adjustment of the initial position of the objective optical system from the position adjusted to the WD at the time of using the BD to the position fitted to the WD at the time of using the CD. Thus, in the case where a plurality of kinds of WD's exists in an optical pick up apparatus and the differences among the WD's are large, a large movable scope of an actuator for focusing becomes necessary at the time of the record or the reproduction of different kinds of optical discs. Consequently, the large movable scope brings about the increment of power consumption, and becomes the cause of the enlargement of an actuator. On the other hand, although a configuration in which the optical disc side is moved into the optical axis direction against the objective optical system can be considered, the high speed rotary drive mechanism for the BD, the DVD and the CD must be moved in that case. Consequently, the configuration is theoretically possible, but it can be said that the configuration cannot be implemented in practice.

Incidentally, as a reason why the WD to each optical disc is different from each other, it is possible to cite the difference in chromatic aberration owing to the differences of wavelengths. In particular, in case of the compatibility of the HD and the DVD, because the thicknesses of the protective layers protecting the information recording surfaces of both of them are 0.6 mm, and are almost the same, the difference of the chromatic aberrations owing to the differences in the wavelengths becomes the chief cause of the difference of the WD's.

Here, if the respective WD's, for example, each WD of the BD, the DVD and the CD can be made in agreement with one WD, it becomes needless to perform the adjustment of the WD's by driving an actuator. Thereby, the power consumption can be suppressed, and the actuator can be made to be small in size.

As a method of making the WD's in agreement with one another, a method of making each WD be in substantial agreement with one another by differentiating the angle of divergence or the angle of convergence of a light flux entering the objective optical system (including a parallel light flux) at the times of using the BD, the DVD and the CD can be considered.

Moreover, as a correction method of the WD's caused by the differences of the wavelengths of the light fluxes used for a plurality of optical discs and the differences of the thicknesses of the protective layers, a technique of providing a diffractive structure to an objective optical system constituting an optical pick up apparatus to make the WD's almost agree with each other by using the difference of the orders of diffraction of the DVD and the CD is conventionally known (see, for example, Published Unexamined Japanese Patent Application No. 2003-66324).

Here, the invention disclosed in Published Unexamined Japanese Patent Application No. 2003-66324 concerns a method of making the WD's be almost the same by utilizing the difference of the orders of diffraction of the DVD and the CD by proving a diffractive structure diffracting the light fluxes of both the DVD and the CD into the objective optical system as the method of making the WD's be almost the same at the time of achieving the compatibility of the DVD and the CD. However, in such a technique, because the technique adopts the configuration of giving a diffraction operation to each of the DVD and the CD, the light availability falls, which is not preferable. Moreover, when the technique is applied to a compatible configuration including the BD and HD DVD, especially to a thee-compatible construction of theses optical discs, the DVD and the CD, the wavelength of the light flux to be used is short, and the NA is large, and further the differences of the protective layers are large. Consequently, it is impossible to design a diffraction structure having a performance of giving a suitable diffraction operation to all of the light fluxes of the three kinds of wavelengths. As a result, there is a problem of being unable to perform a sufficient correction of the WD's cannot be performed.

However, when the technique is applied to the achieving of the compatibility of the high density optical disc, the DVD and the CD, a problem is produced. That is, as for the high density optical disc, the wavelength of the light flux to be used is short; the NA is large; and the difference of the thickness of the protective layer is large. Consequently, it is impossible to design a diffractive structure possessing performance giving a diffraction operation pertinently to all of the light fluxes of the three wavelengths. As a result, no sufficient corrections of the WD's can be performed.

### SUMMARY OF THE INVENTION

In accordance with the first aspect of the invention, an objective optical system for use in an optical pick up apparatus in which recording and/or reproducing information is conducted for a first optical disc equipped with a protective layer having a thickness t₁ by using a first light flux having a first wavelength λ₁ emitted from a first light source and recording and/or reproducing information is conducted for a second optical disc equipped with a protective layer having thickness t₂ (t₂≧t₁) by using a second light flux having a second wavelength λ₂ (λ₂>λ₁) emitted from a second light source, comprising:

an optical surface forming a first diffractive structure, wherein the first diffractive structure provides a diffractive operation for the second light flux and doesn't provide a diffractive operation for the first light flux,

wherein the objective optical system satisfies the following formula (1):
0.9<WD₁/WD₂<1.1 (1)
where WD₁ represents a first working distance in recording and/or reproducing the information for the first optical disc and WD₂ represents a second working distance in recording and/or reproducing the information for the second optical disc.

In accordance with the second aspect of the invention, an optical pick up apparatus is equipped with the objective optical system of the first aspect of the invention.

In accordance with the third aspect of the invention, an objective optical system for use in an optical pick up apparatus in which recording and/or reproducing information is conducted for a first optical disc equipped with a protective layer having a thickness t₁ by using a first light flux having a first wavelength λ₁ emitted from a first light source and recording and/or reproducing information is conducted for a second optical disc equipped with a protective layer having a thickness t₂ (t₂≧t₁) by using a second light flux having a second wavelength λ₂ (λ₂>λ₁) and being emitted from a second light source and recording and/or reproducing information is conducted for a third optical disc equipped with a protective layer having a thickness t₃ (t₃>t₂) by using a third light flux having a third wavelength λ₃ (λ₃>λ₂) and being emitted from a third light source, comprising:

a first optical surface forming a first diffractive structure, wherein the first diffractive structure provides a diffractive operation for the second light flux and doesn't provide a diffractive function for the first light flux and the third light flux; and

a second optical surface forming a second diffractive structure, wherein the second optical surface provides a diffractive operation for the third light flux and doesn't provide a diffractive operation for the first light flux and the second light flux,

wherein the objective optical system satisfies at least one formula between the following formulas (1) and (2):
0.9<WD₁/WD₂<1.1 (1)
0.9<WD₁/WD₃<1.1 (2)
where WD₁ represents a first working distance at a time of recording and/or reproducing information for the first optical disc and WD₂ represents a second working distance at a time of recording and/or reproducing information for the second optical disc and WD₃ represents a third working distance at a time of recording and/or reproducing information for the third optical disc.

In accordance with the fourth aspect of the invention, an optical pick up apparatus is equipped with the objective optical system of the third aspect of the invention.

In accordance with the fifth aspect of the invention, an optical pick up apparatus in which recording and/or reproducing information is conducted for a first optical disc equipped with a protective layer having a thickness ti by using a first light flux having a first wavelength λ₁ (350 nm≦λ₁≦450 nm) emitted from a first light source and recording and/or reproducing information is conducted for a second optical disc equipped with a protective layer having a thickness t₂(t₂≧t₁) by using a second light flux having a second wavelength λ₂ (λ₂>λ₁) emitted from a second light source and recording and/or reproducing information is conducted for a third optical disc equipped with a protective layer having a thickness t₃ (t₃>t₂) by using a third light flux having a third wavelength λ₃ (λ₃>λ₂) emitted from a third light source, comprising:

an objective optical system including a diffractive optical element having a first diffractive structure, wherein the first diffractive structure provides a diffractive operation for the second light flux and doesn't provide a diffractive operation for the first light flux and the third light flux, and a light converging element for converging the first to the third light fluxes having transmitted the diffractive optical device on information recording surfaces of the first to the third optical discs, respectively,

wherein the objective optical system satisfies the following formula (1):
0.9<WD₁/WD₂<1.1 (1)
where WD₁ represents a first working distance at a time of recording and/or reproducing information for the first optical disc and WD₂ represents a second working distance at a time of recording and/or reproducing information for the second optical disc.

In accordance with the sixth aspect of the invention, an optical pick up apparatus in which recording and/or reproducing information is conducted for a first optical disc equipped with a protective layer having a thickness t₁ by using a first light flux having a first wavelength λ₁ (350 nm≦λ₁≦450 nm) emitted from a first light source and recording and/or reproducing information is conducted for a second optical disc equipped with a protective layer having a thickness t₂(t₂≧t₁) by using a second light flux having a second wavelength λ₂ (λ₂>λ₁) and being emitted from a second light source and recording and/or reproducing information is conducted for a third optical disc equipped with a protective layer having a thickness t₃ (t₃>t₂) by using a third light flux having a third wavelength λ₃ (λ₃>λ₂) and being emitted from a third light source, comprising:

an objective optical system including

a diffractive optical element having a second diffractive structure wherein the second diffractive structure provides a diffractive operation for the third light flux and doesn't provide a diffractive operation for the first light flux and the second light flux, and

a light converging element for converging the first to the third light fluxes having transmitted the diffractive optical device on information recording surfaces of the first to the third optical discs, respectively,

wherein the objective optical system satisfies the following formula (2):
0.9<WD₁/WD₃<1.1 (2)
where WD₁ represents a first working distance at a time of recording and/or reproducing information for the first optical disc and WD₃ represents a third working distance at a time of recording and/or reproducing information for the third optical disc.

In accordance with the seventh aspect of the invention, an optical pick up apparatus in which recording and/or reproducing information is conducted for a first optical disc equipped with a protective layer having a thickness t₁ by using a first light flux having a first wavelength λ₁ (350 nm≦λ₁≦450 nm) emitted from a first light source and recording and/or reproducing information is conducted for a second optical disc equipped with a protective layer having a thickness t₂(t₂≧t₁) by using a second light flux having a second wavelength λ₂ (λ₂>λ₁) and being emitted from a second light source and recording and/or reproducing information is conducted for a third optical disc equipped with a protective layer having a thickness t₃ (t₃>t₂) by using a third light flux having a third wavelength λ₃ (λ₃>λ₂) and being emitted from a third light source, comprising:

an objective optical system including a diffractive optical element having a first diffractive structure and a second diffractive structure, wherein the first diffractive structure provides a diffractive operation for the second light flux and doesn't provide a diffractive operation for the first light flux and the third light flux and wherein the second diffractive structure provides a diffractive operation for the third light flux and doesn't provide a diffractive operation for the first light flux and the second light flux, and

a light converging element for converging the first to the third light fluxes having transmitted the diffractive optical device on information recording surfaces of the first to the third optical discs, respectively,

wherein the objective optical system satisfies both of the following formulae (1) and (2):
0.9<WD₁/WD₂<1.1 ( 1 )
0.9<WD₁/WD₃<1.1 (2)
where WD₁ represents a first working distance at a time of recording and/or reproducing information for the first optical disc and WD₂ represents a second working distance at a time of recording and/or reproducing information for the second optical disc and WD₃ represents a third working distance at a time of recording and/or reproducing information for the third optical disc.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein:

FIG. 1 is a plan view of the principal part showing the configuration of an optical pick up apparatus;

FIG. 2 is a diagram showing the structure of an objective optical system;

FIG. 3 is a diagram showing the structure of an objective optical system;

FIG. 4 is a diagram showing the structure of an objective optical system; and

FIG. 5 is a diagram showing the structure of an objective optical system.

### DETAILED DESCRIPTION OF THE PREFERRED EMBODIMENTS

### First Embodiment

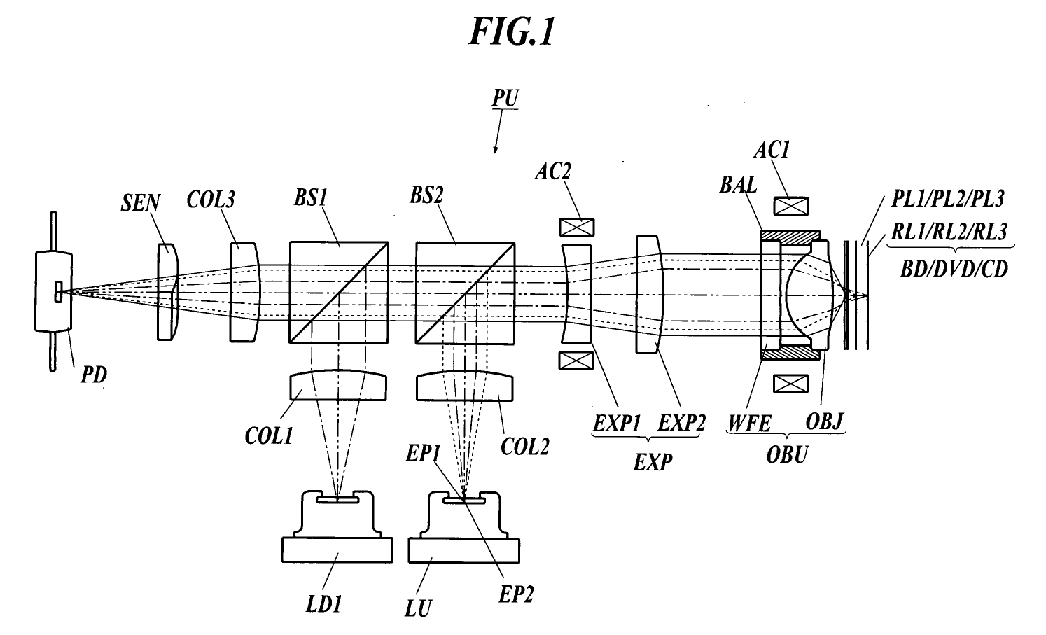

In the following, a first embodiment of the present invention is described using the attached drawings. First, an objective optical system and an optical pick up apparatus using the objective optical system of the present invention are described using FIG. 1.

FIG. 1 is a diagram roughly showing the configuration of an optical pick up apparatus PU which can perform the record/reproduction of information pertinently to any of a high density optical disc BD (a first optical disc), DVD (a second optical disc) and CD (a third optical disc). The optical specifications of the BD are: a first wavelength λ₁=405 nm; the thickness t₁ of a protective layer PL1: t₁=0.1 mm; a numerical aperture NA=0.85. The optical specifications of the DVD are: a wavelength λ₂=655 nm; the thickness t₂ of a protective layer PL 2: t₂=0.6 mm; and a numerical aperture NA₂=0.65. The optical specifications of the CD are: a third wavelength λ₃=785 nm; the thickness t₃ of a protective layer PL₃: t₃=1.2 mm; and numerical aperture NA₃=0.45. However, the combinations of the wavelengths, the thicknesses of the protective layers, and the numerical apertures are not restricted to the above.

The optical pick up apparatus PU is composed of a blue-violet semiconductor laser LD1 (a first light source), which emits light at the time of performing the record/reproduction of information of a BD and emits a blue-violet laser light flux of 405 nm (a first light flux); a laser light source unit for DVD/CD LU including a first luminous point EP1 (a second light source), which emits light at the time of performing the record/reproduction of information of a DVD and emits a red laser light flux of 655 nm (a second light flux), and a second luminous point EP2 (a third light source), which emits light at the time of performing the record/reproduction of information of a CD and emits an infrared laser light flux of 785 nm (a third light flux), the first luminous point EP1 and the second luminous point EP2 formed on a chip; a photo-detector PD for common use for BD/DVD/CD; an objective optical system OBU composed of a diffractive optical element WFE and an objective optical system OBU, both the surface of which are formed to be aspheric surfaces, and which has a function of condensing a laser light flux having transmitted the diffractive optical element WFE on information recording surfaces RL1, RL2 and RL3; a two-spindle actuator AC1; a one-spindle actuator AC2; an expander lens EXP composed of a first lens EXP1 having negative refractive power in paraxial and a second lens EXP2 having positive refractive power in paraxial; a first polarizing beam splitter BS1; a second polarizing beam splitter BS2; a first collimating lens COL1; a second collimating lens COL2; a third collimating lens COL3; and a sensor lens SEN for adding astigmatism to reflected light fluxes from the information recording surfaces RL1, RL2 and RL3. Incidentally, a blue-violet SHG laser can be used as the light source for the BD besides the blue-violet semiconductor laser LD1.

When the record/reproduction of information of a BD is performed with the optical pick up apparatus PU, after the first lens EXP1 is variably adjusted along the optical axis with the one-spindle actuator AC2 in order that a blue-violet laser light flux may be emitted from the expander lens EXP in the state of a parallel light flux, the blue-violet semiconductor laser LD1 is made to emit light. A diverged light flux emitted from the blue-violet semiconductor laser LD 1, is reflected by the first polarizing beam splitter BS1 after having been converted into a parallel light flux by the first collimating lens COL1, as the light ray path is drawn with solid-lines in FIG. 1, and passes the second polarizing beam splitter BS2. Then, after the diameter thereof has been expanded by transmitting the first lens EXP1 and the second lens EXP2, the light flux diameter of the parallel light flux is regulated by a not shown iris STO, and then the parallel light flux becomes a spot formed on the information recording surface RL1 through a protective layer PL1 of the BD by the objective optical system OBU. The objective optical system OBU performs focusing and tracking by the two-spindle actuator AC1 arranged around it.

Incidentally, the detailed description about the objective optical system OBU will be described later.

A reflected light flux modulated by an information pit on the information recording surface RL1 again transmits the objective optical system OBU, the second lens EXP2, the first lens EXP1, the second polarizing beam splitter BS2 and the first polarizing beam splitter BS1. After that, the reflected light flux becomes a converging light flux at the time of passing the third collimating lens COL3, and astigmatism is added by the sensor lens SEN. Then, the converging light flux converges on the light receiving surface of the photo-detector PD. Then, the information recorded on the BD can be read using the output signal of the photo-detector PD.

Moreover, when the record/reproduction of information of a DVD is performed in the optical pick up apparatus PU, the luminous point EP1 is made to emit light after the first lens EXP1 has been variably adjusted along the optical axis by the one-spindle actuator AC2 in order that the red laser light flux is emitted from the expander lens EXP in the state of a parallel light flux. After the diverged light flux emitted from the luminous point EP1 has been converted to a parallel light flux by the second collimating lens COL2, as the light ray path thereof is drawn by broken lines in FIG. 1, the converted parallel light flux is reflected by the second polarizing beam splitter BS2. The diameter of the reflected light flux is expanded by transmitting the first lens EXP1 and the second lens EXP2, and then the expanded light flux becomes a spot formed on the information recording surface RL2 by the objective optical system OBU through a protective layer PL2 of the DVD. The objective optical system OBU performs focusing and tracking by the two-spindle actuator AC1 arranged around it.

A reflected light flux modulated by an information pit on the information recording surface RL2 again transmits the objective optical system OBU, the second lens EXP2, the first lens EXP1, the second polarizing beam splitter BS2 and the first polarizing beam splitter BS1. After that, the reflected light flux becomes a converging light flux at the time of passing the third collimating lens COL3, and astigmatism is added by the sensor lens SEN. Then, the converging light flux converges on the light receiving surface of the photo-detector PD. Then, the information recorded on the DVD can be read using the output signal of the photo-detector PD.

Moreover, when the record/reproduction of information of a CD is performed in the optical pick up apparatus PU, the luminous point EP2 is made to emit light after the first lens EXP1 has been variably adjusted along the optical axis by the one-spindle actuator AC2 in order that the red laser light flux is emitted from the expander lens EXP in the state of a parallel light flux. After the diverged light flux emitted from the luminous point EP2 has been converted to a gentle diverged light flux by the second collimating lens COL2, as the light ray path thereof is drawn by alternate long and short dash lines in FIG. 1, the converted diverged light flux is reflected by the second polarizing beam splitter BS2. The diameter of the reflected light flux is expanded and the reflected light flux is converted to a diverged light flux by transmitting the first lens EXP1 and the second lens EXP2, and then the converted diverged light flux becomes a spot formed on the information recording surface RL3 by the objective optical system OBU through a protective layer PL3 of the CD. The objective optical system OBU performs focusing and tracking by the two-spindle actuator AC1 arranged around it.

A reflected light flux modulated by an information pit on the information recording surface RL2 again transmits the objective optical system OBU, the second lens EXP2, the first lens EXP1, the second polarizing beam splitter BS2 and the first polarizing beam splitter BS1. After that, the reflected light flux becomes a converging light flux at the time of passing the third collimating lens COL3, and astigmatism is added by the sensor lens SEN. Then, the converging light flux converges on the light receiving surface of the photo-detector PD. Then, the information recorded on the CD can be read using the output signal of the photo-detector PD.

The optical pickup equipment PU can correct the spherical aberration of a spot formed on the information recording surface RL1 of the BD by driving the first lens EXP1 in the optical axis direction with the one-spindle actuator AC2. The causes of the occurrence of the spherical aberration corrected by the variable adjustment of the first lens EXP1 are, for example, the dispersion of the wavelength of the blue-violet semiconductor laser LD1 caused by a manufacturing error, a refractive index change and a refractive index distribution of the objective optical system OBU caused by a temperature change, a focus jump between information recording layers of a multi-layer disk such as a two-layer disk and a four-layer disk, a thickness dispersion and a thickness distribution of the protective layer PL1 of the BD caused by a manufacturing error, and the like.

Moreover, as a method of correcting the spherical aberration of a spot formed on the information recording surface RL1 of the BD, a method of using a phase control device using liquid crystal may be used in addition to the method of driving the lens EXP1 into the optical axis direction as described above. Because such a method of correcting the spherical aberration by the phase control device is publicly known, the detailed description thereof is omitted here.

Moreover, although the optical pick up apparatus PU uses the laser light source unit for DVD/CD LU, in which the first luminous point EP1 and the second luminous point EP2 are formed on one chip, the laser light source unit is not limited to such a configuration. A laser light source unit for BD/DVD/CD in which also a luminous point emitting the first light flux for the BD is formed on the same chip may be used. Alternatively, a laser light source unit for BD/DVD/CD, in which three laser light sources of a blue-violet semiconductor laser, a red semiconductor laser and an infrared semiconductor laser are housed in a housing may be used.

Moreover, although the light sources and the photo-detector PD are configured to be arranged in separate bodies in the present embodiment, the configuration is not limited to such one. A laser light source module in which light sources and an optical detector are integrated may be used.

Next, the configuration of the objective optical system OBU is described.

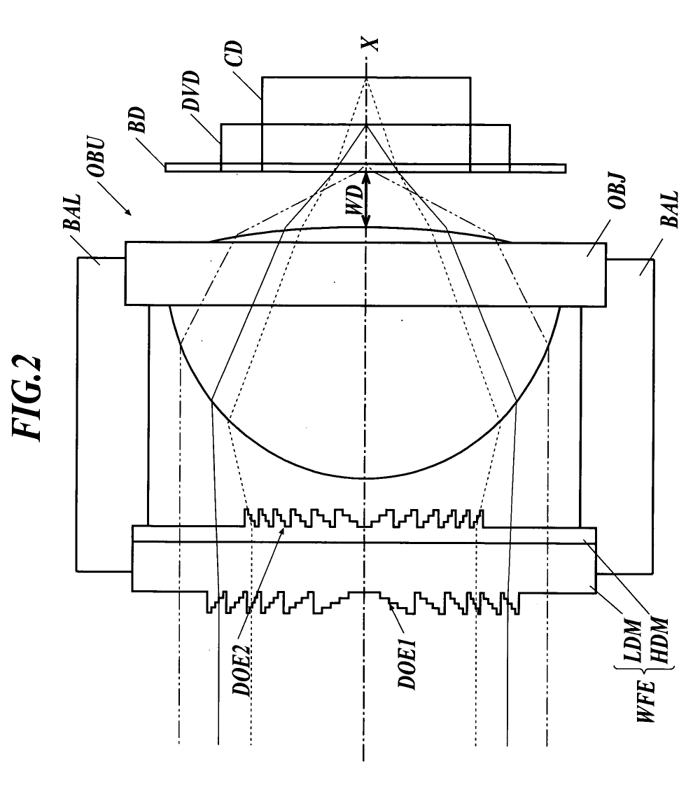

The objective optical system OBU is, as shown in FIG. 2, configured of the diffractive optical element WFE and the condensing element OBJ, both the surfaces of which are formed as aspheric surfaces, and which has the function of condensing the laser light flux having transmitted the diffractive optical element WFE on the information recording surface of the optical disc. Moreover, the diffractive optical element WFE is made of a resin, and the condenser lens OBJ is made of glass. Both of the diffractive optical element WFE and the condenser lens OBJ are configured to be integrated into one body to have the same axis around an optical axis X with a mirror frame (holding member) BAL. Furthermore, the diffractive optical element WFE is made of materials different on the light source side and the optical disc side. The light source side of the diffractive optical element WFE is made of a low dispersion material LDM having an Abbe number of 55 on a d-line and a refractive index of 1.50 on the d-line. The optical disc side of the diffractive optical element WFE is made of a high dispersion material HDM having the Abbe number of 23 on the d-line and the refractive index of 1.63 on the d-line. Incidentally, the condenser lens OBJ may be made of a resin.

On the optical surface on the light source side of the diffractive optical element WFE, which is made of the low dispersion material LDM, a wavelength selection diffractive structure (a first diffractive structure) DOE1 is formed. The wavelength selection diffractive structure DOE1 is a structure in which patterns each having a stepwise cross sectional form including an optical axis are arranged in concentric circles, and is a structure in which steps are shifted by the height for the number of steps (for four steps in FIG. 2) corresponding to the number of level surfaces every number A (A=5 in FIG. 2) of the predetermined level surfaces.

In the wavelength selection diffractive structure DOE1, the depth d₁ of one step formed in each pattern is set to a value calculated by d₁=2×λ₁/(n₁₁−1)=1.541 (μm) . However, λ₁ denotes the first wavelength expressed by the micron (here λ₁=0.405), and n₁₁ denotes a refractive index (n₁₁=1.515468 here) of the low dispersion material LDM to the first wavelength λ₁.

When the first light flux enters the wavelength selection diffractive structure DOE1, 2×λ₁ (nm) of optical path difference is produced by the step. Consequently, the wavefronts of the first light flux having passed adjoining level surfaces come to overlap each other in the state of being shifted from each other by two wavelengths. Hereby, the first light flux transmits the wavelength selection diffractive structure DOE1 without receiving any diffraction operations as it is. Incidentally, in the following descriptions, the light flux transmitting the diffractive structure without receiving the diffraction operation thereof as it is called as oth diffraction light.

Moreover, when the third light flux enters the wavelength selection diffractive structure DOE1, d₁×(n₁₃−1)/λ₃=0.99 (×λ₃)≅1 (×λ₃) of optical path difference is produced by the step. Consequently, the wavefronts of the third light flux having passed adjoining level surfaces come to overlap each other in the state of being shifted from each other by one wavelength. Hereby, the third light flux transmits the wavelength selection diffractive structure DOE1 without receiving any diffraction operations as it is. Incidentally, λ₃ denotes the third wavelength by the micron unit (hereupon λ₃=0.785), and n₁₃ denotes a refractive index of the low dispersion material LDM to the third wavelength λ₃ (hereupon n₁₃=1.493777).

On the other hand, when the second light flux enters the wavelength selection diffractive structure DOE1, d₁×(n₁₂−1)/λ₂=1.19 (×λ₂) of optical path difference is produced by the step. Because a substantial optical path difference obtained by subtracting the equi-phase optical path difference for one wavelength becomes 0.19 (×λ₂) 0.2 (×λ₂), the wavefronts of the second light flux having passed adjoining level surfaces come to be shifted from each other by 0.2 wavelength. Because the optical path difference of the whole pattern composed of five level surfaces is 0.2×5 (×λ₂)=1 (×λ₂), the wavefronts of the second light flux having passed adjoining level surfaces come to overlap each other in the state of being shifted from each other by one wavelength, and the second light flux becomes diffraction light diffracted into the 1^{st} order direction. Incidentally, λ₂ denotes the second wavelength by a micron unit (hereupon λ₂=0.655), and n₁₂ denotes a refractive index of the low dispersion material LDM to the second wavelength λ₂ (hereupon n₁₂=1.497294).

In this manner, in the objective optical system OBU, the second light flux is selectively diffracted by the wavelength selection diffractive structure DOE1, and thereby the spherical aberration arisen from the difference of the thicknesses of the protective layers of the BD and the DVD is corrected.

Moreover, in each pattern of the wavelength selection diffraction structure DOE1, the steps are formed so that the optical path length of a level surface farther from the optical axis may become longer than the optical path length of a level surface nearer to the optical axis. The configuration indicates that the wavelength selection diffraction structure DOE1 has negative diffractive power. In the objective optical system OBU, the second light flux having entered as a parallel light flux is converted into a diverged light flux by the wavelength selection diffractive structure DOE1. Thereby, the back focal distance of the second light flux is extended to make the WD₁ at the time of using the BD and the WD₂ at the time of using the DVD coincide with each other.

Moreover, the diffraction efficiencies of the wavelength selection diffractive structure DOE1 to the respective light fluxes are 100%, 87% and 99% to the first, the second and the third light fluxes, respectively. That is, high diffraction efficiencies are obtained to any of the light fluxes.

Moreover, on the optical surface on the optical disc side of the diffractive optical element WFE made of the high dispersion material HDM, a wavelength selection diffractive structure (a second diffractive structure) DOE2 is formed. The wavelength selection diffractive structure DOE2 is a structure in which patterns each having a stepwise cross sectional form including an optical axis are arranged in concentric circles, and is a structure in which steps are shifted by the height for the number of steps (for three steps in FIG. 2) corresponding to the number of level surfaces every number B (B=4 in FIG. 2) of the predetermined level surfaces.

In the wavelength selection diffractive structure DOE2, the depth d₂ of one step formed in each pattern is set to a value calculated by d₂=7×λ₁/(n₂₁−1)=4.159 (μm) . However, n₂₁ denotes a refractive index (n₂₁=1.681692 here) of the high dispersion material HDM to the first wavelength λ₁.

When the first light flux enters the wavelength selection diffractive structure DOE2, 7×λ₁ (nm) of optical path difference is produced by the step. Consequently, the wavefronts of the first light flux having passed adjoining level surfaces come to overlap each other in the state of being shifted from each other by seven wavelengths. Hereby, the first light flux transmits the wavelength selection diffractive structure DOE2 without receiving any diffraction operations as it is.

Moreover, when the second light flux enters the wavelength selection diffractive structure DOE2, d₂×(n₂₂−1)/λ₂=3.95 (×λ₂)≅4 (×λ₂) of optical path difference is produced by the step. Consequently, the wavefronts of the second light flux having passed adjoining level surfaces come to overlap each other in the state of being shifted from each other by four wavelengths. Hereby, the second light flux transmits the wavelength selection diffractive structure DOE2 without receiving any diffraction operations as it is. Incidentally, n₂₂ denotes a refractive index of the high dispersion material HDM to the second wavelength λ₂ (hereupon n₂₂=1.622309).

On the other hand, when the third light flux enters the wavelength selection diffractive structure DOE2, d₂×(n₂₃−1)/λ₃=3.25 (×λ₃) of optical path difference is produced by the step. Because a substantial optical path difference obtained by subtracting the equi-phase optical path difference for three wavelengths becomes 0.25 (×3), the wavefronts of the third light flux having passed adjoining level surfaces come to be shifted from each other by 0.25 wavelength. Because the optical path difference of the whole pattern composed of four level surfaces is 0.25×4 (×λ₃)=1 (×λ₃), the wavefronts of the third light flux having passed adjoining level surfaces come to overlap each other in the state of being shifted from each other by one wavelength, and the third light flux becomes diffraction light diffracted into the 1^{st} order direction. Incidentally, n₂₃ denotes a refractive index of the high dispersion material HDM to the third wavelength λ₃ (hereupon n₂₃=1.613025).

In this manner, in the objective optical system OBU, the third light flux is selectively diffracted by the wavelength selection diffractive structure DOE2, and thereby the spherical aberration arisen from the difference of the thicknesses of the protective layers of the BD and the DVD is corrected.

Moreover, in each pattern of the wavelength selection diffraction structure DOE2, the steps are formed so that the optical path length of a level surface farther from the optical axis may become longer than the optical path length of a level surface nearer to the optical axis. The configuration indicates that the wavelength selection diffraction structure DOE2 has negative diffractive power. In the objective optical system OBU, the third light flux having entered as a parallel light flux is converted into a diverged light flux by the wavelength selection diffractive structure DOE2. Thereby, the back focal distance of the third light flux is extended to make the WD₁ at the time of using the BD and the WD₂ at the time of using the DVD coincide with each other.

Moreover, the diffraction efficiencies of the wavelength selection diffractive structure DOE2 to the respective light fluxes are 100%, 89% and 81% to the first, the second and the third light fluxes, respectively. That is, high diffraction efficiencies are obtained to any of the light fluxes.

Moreover, because the wavelength selection diffraction structure DOE1 is formed only in the numerical aperture NA₂ of the DVD, the second light flux passing the outside region of the numerical aperture NA₂ becomes a flare component on the information recording surface RL2 of the DVD, and thus the diffractive optical element WFE is configured so that the aperture restriction to the DVD may be performed automatically.

Similarly, because the wavelength selection diffraction structure DOE2 is formed only in numerical aperture NA₃ of the CD, the light flux passing the outside region of the numerical aperture NA₃ becomes a flare component on the information recording surface RL3 of the CD, and thus the diffractive optical element WFE is configured so that the aperture restriction to the CD may be performed automatically.

Moreover, although the diffractive optical element WFE and the condenser lens OBJ are integrated with each other with the mirror frame BAL in the objective optical system OBU, when the diffractive optical element WFE and the condenser lens OBJ are integrated with each other, as long as the mutual relative positional relation of the diffractive optical element WFE and the condenser lens OBJ is not held to be changed, a method of fitting the flange units of the diffractive optical element WFE and the condenser lens OBJ into each other to fix them may be adopted besides the method of using the mirror frame BAL.

### Second Embodiment

Next, a second embodiment of the present invention is described. The same marks as those of the first embodiment are attached to the same configurations as those of the first embodiment, and the descriptions of the same configurations are omitted.

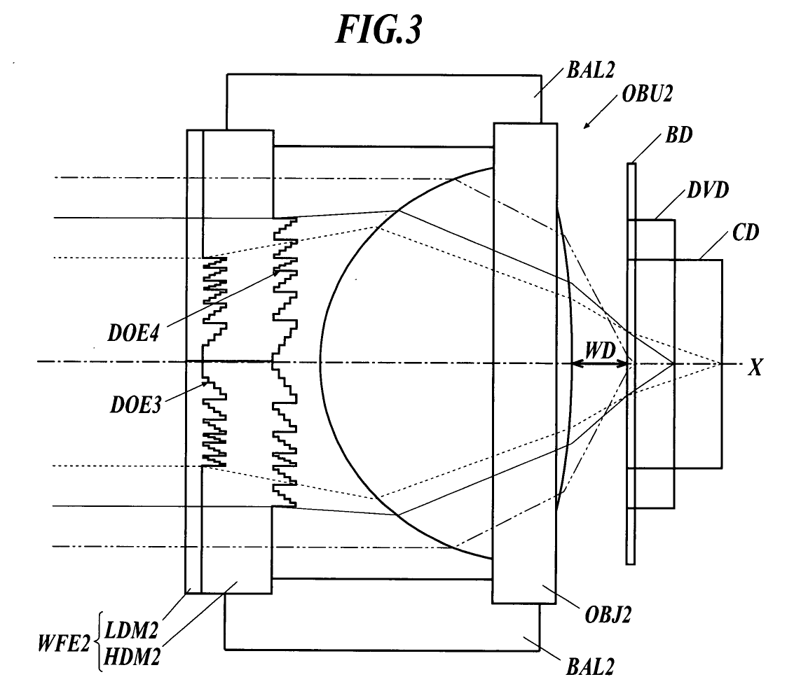

As shown in FIG. 3, an objective optical system OBU2 of the present embodiment has the following features: a diffractive optical element WFE2 is configured to be made of materials different on the light source side and the optical disc side; a wavelength selection diffractive structure DOE3 (the first diffractive structure) diffracting the second light flux selectively is formed on the optical surface on the optical disc side; and a wavelength selection diffractive structure DOE4 (the second diffractive structure) diffracting the third light flux selectively is formed on the joint surface of the different materials. The material on the light source side between the different materials is made of a high dispersion material HDM having an Abbe number of 27 on a d-line and a refractive index of 1.65 on the d-line. The material on the optical disc side is made of a low dispersion material LDM having the Abbe number of 55 on the d-line and the refractive index of 1.50 on the d-line.

Because the function and the configuration of the wavelength selection diffraction structure DOE3 are the same as those of the wavelength selection diffraction structure DOE1 in the first embodiment, their detailed descriptions are omitted.

Moreover, the wavelength selection diffractive structure DOE4 formed on the joint surface of the high dispersion material HDM and the low dispersion material LDM has a structure in which patterns each having a cross sectional form including an optical axis made to be stepwise are arranged concentrically, and the structure is formed by shifting steps by the height of the number of steps (by four steps in FIG. 3) corresponding to the number of level surfaces every number B of the predetermined level surfaces (B=5 in FIG. 3).

In the wavelength selection diffractive structure DOE4, the depth d₄ of one step formed in each pattern is set to a value calculated by d₄=2×λ₁/(n₄₁−n₃₁)=4.524 (μm). However, n₄₁ denotes a refractive index of the high dispersion material HDM to the first wavelength λ₁ (hereupon n₄₁=1.694503), and n₃₁ is a refractive index of the low dispersion material LDM to the first wavelength λ₁ (hereupon n₃₁=1.515468).

When the first light flux enters the wavelength selection diffractive structure DOE4, 2×λ₁ (nm) of optical path difference is produced by the step. Consequently, the wavefronts of the first light flux having passed adjoining level surfaces come to overlap each other in the state of being shifted from each other by seven wavelengths. Hereby, the first light flux transmits the wavelength selection diffractive structure DOE4 without receiving any diffraction operations as it is.

Moreover, when the second light flux enters the wavelength selection diffractive structure DOE4, d₄×(n₄₂−n₃₂)/λ₂=1.01 (×λ₂)≅1 (×λ₂) of optical path difference is produced by the step. Consequently, the wavefronts of the second light flux having passed adjoining level surfaces come to overlap each other in the state of being shifted from each other by one wavelength. Hereby, the second light flux transmits the wavelength selection diffractive structure DOE4 without receiving any diffraction operations as it is. Incidentally, n₄₂ denotes a refractive index of the high dispersion material HDM to the second wavelength λ₂ (hereupon n₂=1.643168), and n₃₂ denotes a refractive index of the low dispersion material LDM to the second wavelength λ₂ (hereupon n₃₂=1.497294) On the other hand, when the third light flux enters the wavelength selection diffractive structure DOE4, d₄×(n₄₃−n₃₃)/λ₃=0. 81 (×λ₃) of optical path difference is produced by the step. Because a substantial optical path difference obtained by subtracting the equi-phase optical path difference for one wavelength becomes 0.19 (×λ₃) 0.2 (×λ₃), the wavefronts of the third light flux having passed adjoining level surfaces come to be shifted from each other by 0.2 wavelength. Because the optical path difference of the whole pattern composed of five level surfaces is 0.2×5 (×λ₃)=1 (×λ₃), the wavefronts of the third light flux having passed adjoining patterns come to overlap each other in the state of being shifted from each other by one wavelength, and the third light flux becomes diffraction light diffracted into the 1^{st} order direction. Incidentally, n₄₃ denotes a refractive index of the high dispersion material HDM to the third wavelength λ₃ (hereupon n₄₃=1.634827), and n₃₃ denotes a refractive index of the low dispersion material LDM to the third wavelength λ₃ (hereupon n₃₃=1.493777).

In this manner, in the objective optical system OBU2, the third light flux is selectively diffracted by the wavelength selection diffractive structure DOE4, and thereby the spherical aberration arisen from the difference of the thicknesses of the protective layers of the BD and the CD is corrected.

Moreover, in each pattern on the low dispersion material LDM side in the wavelength selection diffraction structure DOE4, the steps are formed so that the optical path length of a level surface farther from the optical axis may become longer than the optical path length of a level surface nearer to the optical axis. The configuration indicates that the wavelength selection diffraction structure DOE4 has negative diffractive power. In the objective optical system OBU2, the third light flux having entered as a parallel light flux is converted into a diverged light flux by the wavelength selection diffractive structure DOE4. Thereby, the back focal distance of the third light flux is extended to make the WD₁ at the time of using the BD and the WD₃ at the time of using the CD coincide with each other.

Moreover, the diffraction efficiencies of the wavelength selection diffractive structure DOE4 to the respective light fluxes are 100%, 100% and 86% to the first, the second and the third light fluxes, respectively. That is, high diffraction efficiencies are obtained to any of the light fluxes.

### Third Embodiment

Next, a third embodiment of the present invention is described. The same marks as those of the first embodiment are attached to the same configurations as those of the first embodiment, and the descriptions of the same configurations are omitted.

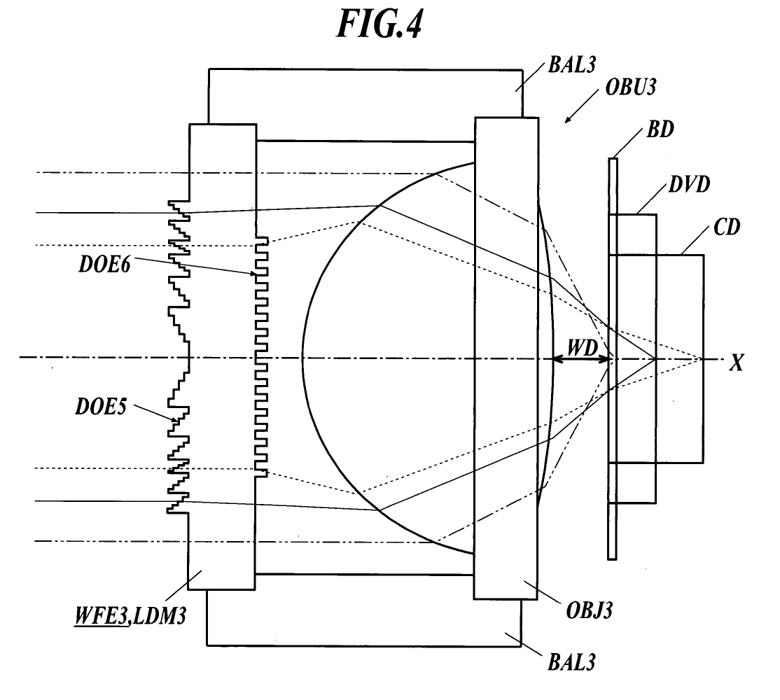

As shown in FIG. 4, an objective optical system OBU3 of the present embodiment has the following features: a diffractive optical element WFE3 is made of a low dispersion materials LDM having the Abbe number of 55; a wavelength selection diffractive structure DOE5 (the first diffractive structure) diffracting the second light flux selectively is formed on the optical surface on the light source side; and a wavelength selection diffractive structure DOE6 (the second diffractive structure) diffracting the third light flux selectively is formed on the optical surface on the optical disc side.

Because the function and the configuration of the wavelength selection diffraction structure DOE5 are the same as those of the wavelength selection diffraction structure DOE1 in the first embodiment, their detailed descriptions are omitted.

Moreover, the wavelength selection diffractive structure DOE6 has a structure in which patterns each has a stepwise cross sectional form including an optical axis are concentrically arranged, and the structure is formed by shifting steps by the height of the number of steps (by one step in FIG. 4) corresponding to the number of level surfaces every number B of the predetermined level surfaces (B=2 in FIG. 4).

In the wavelength selection diffractive structure DOE6, the depth d₆ of one step formed in each pattern is set to a value calculated by d₆=5×λ₁/(n₅₁−1)=3.928 (μm). However, n₅₁ denotes a refractive index of the low dispersion material LDM to the first wavelength λ₁ (hereupon n₅₁=1.515468).

When the first light flux enters the wavelength selection diffractive structure DOE6, 5×λ₁ (nm) of optical path difference is produced by the step. Consequently, the wavefronts of the first light flux having passed adjoining level surfaces come to overlap each other in the state of being shifted from each other by five wavelengths. Hereby, the first light flux transmits the wavelength selection diffractive structure DOE6 without receiving any diffraction operations as it is.

Moreover, when the second light flux enters the wavelength selection diffractive structure DOE6, d₆×(n₅₂−1)/λ₂=2.98 (×λ₂)≅3 (×λ₂) of optical path difference is produced by the step. Consequently, the wavefronts of the second light flux having passed adjoining level surfaces come to overlap each other in the state of being shifted from each other by three wavelengths. Hereby, the second light flux transmits the wavelength selection diffractive structure DOE6 without receiving any diffraction operations as it is. Incidentally, n₅₂ denotes a refractive index of the low dispersion material LDM to the second wavelength λ₂ (hereupon n₅₂=1.497294).

On the other hand, when the third light flux enters the wavelength selection diffractive structure DOE6, d₆×(n₅₃−1)/λ₃=2.47 (×λ₃) of optical path difference is produced by the step. Because a substantial optical path difference obtained by subtracting the equi-phase optical path difference for two wavelengths becomes 0.47 (×λ₃) 0.5 (×λ₃), the wavefronts of the third light flux having passed adjoining level surfaces come to be shifted from each other by 0.5 wavelength. Thereby, almost all the quantity of light of the third light flux entering the wavelength selection diffractive structure DOE is distributed to two pieces of diffracted light of 1^{st} order diffracted light and −1^{st} order diffracted light. In the objective optical system OBU3, the width of each pattern is designed to condense the 1^{st} order diffracted light on the information recording surface RL3 of the CD. Incidentally, n₅₃ denotes a refractive index of the low dispersion material LDM to the third wavelength λ₃ (hereupon n₅₃=1.493777).

In this manner, in the objective optical system OBU3, the third light flux is selectively diffracted by the wavelength selection diffractive structure DOE6 and thereby the spherical aberration arisen from the difference of the thicknesses of the protective layers of the BD and the CD is corrected.

Moreover, in each pattern of the wavelength selection diffraction structure DOE6 the steps are formed so that the optical path length of a level surface farther from the optical axis may become longer than the optical path length of a level surface nearer to the optical axis. The configuration indicates that the wavelength selection diffraction structure DOE6 has negative diffractive power. In the objective optical system OBU3, the third light flux having entered as a parallel light flux is converted into a diverged light flux by the wavelength selection diffractive structure DOE6. Thereby, the back focal distance of the third light flux is extended to make the WD₁ at the time of using the BD and the WD₃ at the time of using the CD coincide with each other.

Moreover, the diffraction efficiencies of the wavelength selection diffractive structure DOE6 to the respective light fluxes are 100%, 100% and 40% to the first, the second and the third light fluxes, respectively. That is, high diffraction efficiencies are obtained to the first and the second light fluxes.

### Fourth Embodiment

Next, a fourth embodiment of the present invention is described. The same marks as those of the first embodiment are attached to the same configurations as those of the first embodiment, and the descriptions of the same configurations are omitted.

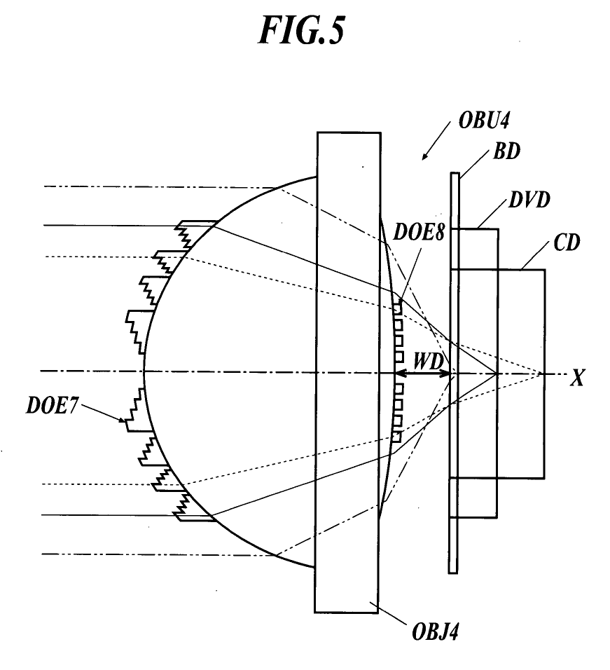

As shown in FIG. 5, an objective optical system OBU4 of the present embodiment has a feature of configuring a diffractive optical element and a condenser lens to be one body. The objective optical system OBU4 is a lens made of a resin, which is configured using a low dispersion material LDM having the Abbe number of 55. A wavelength selection diffractive structure DOE7 (the first diffractive structure) is formed on the optical surface on the light source side of the objective optical system OBU4, and a wavelength selection diffractive structure DOE8 (the second diffractive structure) is formed on the optical surface on the optical disc side of the objective optical system OBU4.

Because the function and the configuration of the wavelength selection diffraction structure DOE7 are the same as those of the wavelength selection diffraction structure DOE1 in the first embodiment, their detailed descriptions are omitted.

Because the function and the configuration of the wavelength selection diffraction structure DOE8 are the same as those of the wavelength selection diffraction structure DOE6 in the third embodiment, their detailed descriptions are omitted.

Although the objective optical systems and optical pick up apparatus by which record/reproduction are possible to three kinds of the optical discs of the high density optical disc BD, the DVD and the CD have been exemplified to be described in the embodiments described above, it is easily understood that the present invention is applicable to the objective optical system and the optical pick up apparatus by which record/reproduction are possible to two kinds of optical discs, the two kinds of the optical discs of the high density optical disc BD and the DVD or the two kinds of the optical discs of the high density optical disc BD and the CD.

For example, it is possible to configure the objective optical system and the optical pick up apparatus by leaving the optical system elements necessary for record/reproduction of these two kinds of optical discs while deleting the other optical system elements, and thereby an optical pickup optical system and an optical pick up apparatus which are more reduced in size, in weight and in cost, and are more simplified in configuration can be realized.

Moreover, in place of the BD, a HD and the other high density optical discs may be applied.

Incidentally, although the configurations in which the WD's are made to be coincide with one another based on the differences in the thicknesses of the protective layers of the respective optical discs are designed in the embodiments described above, there is a case where a configuration in which the WD's are made to coincide with one another in consideration of the difference in chromatic aberration caused by the differences of the wavelengths to the respective optical discs is designed. In particular, in case of applying the HD in place of the BD, because the thicknesses of the protective layers protecting the information recording surfaces of both the HD and the DVD are severally 0.6 mm and they almost coincide with each other, it becomes important to make the difference of the WD based on the difference of the chromatic aberration caused by the difference of the wavelengths coincide with each other.

In the present invention, the preferable ranges of the first wavelength λ₁, the second wavelength λ₂, the third wavelength λ₃, and the thicknesses of the protective layers t₁, t₂ and t₃ are as follows.

nm≦λ₁≦450 nm

nm≦λ₂≦700 nm

nm≦λ₃≦850 nm

mm≦t₁≦0.7 mm

mm≦t₂≦0.7 mm

mm≦t₃≦1.3 mm

### EXAMPLE

Next, a concrete numerical example of the objective optical system OBU shown in FIG. 2 is exemplified.

The present example is a design in which the working distance W₁ at the time of using the BD, the working distance WD₂ at the time of using the DVD, and the working distance WD₃ at the time of using the CD are made to coincide with one another, and the value is 0.7150 mm. The lens data of the present example is shown in Tables 1 and 2.

TABLE 1
specifications

| | | | |
|---|---|---|---|
| λ₁ = 405 nm, | f₁ = 2.200 mm, | NA₁ = 0.85, | d7_{BD} = 0.1000 |
| λ₂ = 655 nm, | f₂ = 2.320 mm, | NA₂ = 0.65, | d7_{DVD} = 0.6000 |
| λ₃ = 785 nm, | f₃ = 2.622 mm, | NA₃ = 0.45, | d7_{CD} = 1.2000 |

paraxial data

| surface | | | | | | | | |
|---|---|---|---|---|---|---|---|---|
| number | r(mm) | d(mm) | n₁ | n₂ | n₃ | n_{d} | ν_{d} | remarks |
| OBJ | | ∞ | | | | | | luminous point |
| 1 | ∞ | 1.0000 | 1.515468 | 1.497294 | 1.493777 | 1.500000 | 55.0 | diffractive |
| 2 | ∞ | 0.1000 | 1.681692 | 1.622309 | 1.61305 | 1.630000 | 23.0 | optical element |
| 3 | ∞ | 0.5000 | | | | | | |
| 4 | 1.50977 | 2.5900 | 1.605256 | 1.586235 | 1.582389 | 1.589127 | 61.3 | condenser lens |
| 5 | −3.98705 | 0.7150 | | | | | | |
| 6 | ∞ | d 7 | 1.622304 | 1.579954 | 1.573263 | 1.585459 | 30.0 | protection layer |
| 7 | ∞ | | | | | | | |

TABLE 2
aspheric coefficient

| | fourth surface | fifth surface |
|---|---|---|
| κ | −0.66091 | −70.33824 |
| A₄ | 0.79412E−02 | 0.99127E−01 |
| A₆ | 0.86416E−04 | −0.10873E+00 |
| A₈ | 0.20333E−02 | 0.80513E−01 |
| A₁₀ | −0.12698E−02 | −0.40782E−01 |
| A₁₂ | 0.28538E−03 | 0.11632E−01 |
| A₁₄ | 0.21720E−03 | −0.13968E−02 |
| A₁₆ | −0.16847E−03 | 0.00000E+00 |
| A₁₈ | 0.45032E−04 | 0.00000E+00 |
| A₂₀ | −0.44433E−05 | 0.00000E+00 |

optical path difference function coefficient

| | first surface | third surface |
|---|---|---|
| dor₁/dor₂/dor₃ | 0/1/0 | 0/0/1 |
| λ_{B} | 655 nm | 785 nm |
| B₂ | 0.25518E−01 | 0.53790E−01 |
| B₄ | −0.54893E−03 | −0.36593E−02 |
| B₆ | 0.10566E−02 | 0.73831E−02 |
| B₈ | −0.40396E−03 | −0.47865E−02 |
| B₁₀ | 0.13935E−03 | 0.20033E−02 |

In Tables 1 and 2, λ₁ (nm), λ₂ (nm) and λ₃ (nm) denote the designed wavelengths of the BD, the DVD and the CD, respectively. f1 (mm), f2 (mm) and f3 (mm) denote the focal distances of the BD, the DVD and the CD, respectively. NA1, NA2 and NA3 denote the numerical apertures of the BD, the DVD and the CD, respectively. r (mm) denotes a radius of curvature. d (mm) denotes a lens interval. n₁, n₂ and n₃ denote refractive indices of the lenses to λ₁, λ₂ and λ₃, respectively. V_{d} denotes an Abbe number of the lens on the d-line. dor₁, dor₂ and dor₃ denote a diffraction order of the diffracted light used for the record/reproduction of the BD, a diffraction order of the diffracted light used for the record/reproduction of the DVD, and a diffraction order of the diffracted light used for the record/reproduction of a CD, respectively. Moreover, it is supposed that an exponential number of 10 (for example, 2.5×10⁻³) is expressed using E (for example, 2.5E-3).

The optical surface on the light source side of the condenser lens OBJ (a fourth surface) and the optical surface on the optical disc side thereof (a fifth surface) are severally shaped in an aspheric surface, and the aspheric surface can be expressed by a numerical formula obtained by substituting a coefficient in the table for the following aspheric surface shape formula.
[Aspheric Surface Expression Formula]

$$z = ( {y}^{2} / R ) / [ 1 + \sqrt{\{ 1 - ( K + 1 ) {( y / R )}^{2} \}} ] + {A}_{4} {y}^{4} + {A}_{6} {y}^{6} + {A}_{8} {y}^{8} + {A}_{10} {y}^{10} + {A}_{12} {y}^{12} + {A}_{14} {y}^{14} + {A}_{16} {y}^{16} + {A}_{18} {y}^{18} + {A}_{20} {y}^{20}$$

where

z: the shape of the aspheric surface (a distance in the direction along the optical axis from a plane tangent to the surface vertex of an aspheric surface);

y: a distance from the optical axis;

R: a radius of curvature;

K: Korenich coefficient; and

A₄, A₆, A₈, A₁₀, A₁₂, A₁₄, A₁₆, A₁₈ and A₂₀: aspheric surface coefficients.

Moreover, the wavelength selection diffractive structure DOE1 and the wavelength selection diffractive structure DOE2 are expressed by optical path differences added to incidence light fluxes by the respective diffraction structures. Such an optical path difference is expressed by an optical path difference function φ (mm) obtained by substituting a coefficient in the table for the following formula expressing the optical path difference function.

8 Optical Path Difference Function]
φ=dor×λ/λ_{B}×(B₂y²+B₄y⁴+B₆y⁶+B₈y⁸+B₁₀y¹⁰)
where

φ: an optical path difference function;

λ: a wavelength of a light flux entering the diffractive structure;

λ_{B}: blazed wavelength

dor: the diffraction order of diffracted light used of the record/reproduction of an optical disc;

y: a distance from the optical axis; and

B₂, B₄, B₆, B₈, B₁₀: optical path difference function coefficients.

As described above, an objective optical system for use in an optical pick up apparatus in which recording and/or reproducing information is conducted for a first optical disc equipped with a protective layer having a thickness t₁ by using a first light flux having a first wavelength λ₁ emitted from a first light source and recording and/or reproducing information is conducted for a second optical disc equipped with a protective layer having thickness t₂ (t₂≧t₁) by using a second light flux having a second wavelength λ₂ (λ₂>λ₁) emitted from a second light source, comprises:

an optical surface forming a first diffractive structure, wherein the first diffractive structure provides a diffractive operation for the second light flux and doesn't provide a diffractive operation for the first light flux,

wherein the objective optical system satisfies the following formula (1):
0.9<WD₁/WD₂<1.1 (1)
where WD₁ represents a first working distance in recording and/or reproducing the information for the first optical disc and WD₂ represents a second working distance in recording and/or reproducing the information for the second optical disc.

In this manner, because it becomes possible to independently control the angle of divergence or the angle of convergence of each of the first light flux (e.g. blue) and the second light flux (e.g. red) by providing the first diffractive structure selectively diffracting only the second light flux, it is possible to make the WD's at the time of using the first optical disk (e.g. a high density optical disc) and the second optical disc (e.g. a DVD) almost agree with each other (i.e. to make satisfy formula (1)) without damaging the focusing property of each of the first and the second optical discs.

Incidentally, in the present specification, it is supposed that the high density optical disc includes a magneto-optical disc, an optical disc equipped with a protective film having a thickness of from about several nm to about several tens nm on the information recording surface of the optical disc, and an optical disc equipped with a protective layer or a protective film having a thickness of zero besides the BD and the HD described above.

Moreover, in the present specification, the DVD is a general term of the optical discs of the DVD series such as a DVD-ROM, a DVD-Video, a DVD-Audio, a DVD-RAM, a DVD-R, a DVD+RW, a DVD+R and a DVD+RW, and the CD is a general term of the optical discs of the CD series such as a CD+ROM, a CD+Audio, a CD+Video, a CD+R and a CD+RW.

Moreover, in the present specification, the “objective optical system” indicates an optical system which is positioned at a position opposed to an optical disc in an optical pick up apparatus and includes a function of condensing a light flux emitted from a light source on the information recording surface of the optical disc, and further which is made to be movable at least in an optical axis direction by an actuator. The “objective optical system” in the present specification may be configured of a lens group, or may be configured of a plurality of lens groups.

Moreover, it is preferable that the cross sectional form including an optical axis of the first diffractive structure includes a plurality of stepped patterns which are formed concentrically on the optical surface, wherein each of the stepped patterns is formed by shifting the optical surface by a predetermined height at every number A of certain level surfaces, wherein the predetermined height is equivalent to a height corresponding to the number A of the certain level surfaces.

By adopting such a configuration, it becomes possible to give the first diffractive structure the diffraction characteristic as described in claim 1.

Moreover, in case of using a light source having a wavelength shifted from a designed wavelength as the first light source, the optical pattern difference added by each step constituting each pattern is slightly sifted from the integral multiples of the wavelength. Consequently, a local spherical aberration is produced in a pattern. But, because a wavefront having the local spherical aberration is broken off at a part where the step is shifted by the height for the number of steps corresponding to the number of the level surfaces, the macroscopic (average) wavefront becomes flat. In this manner, by making the first diffractive structure a structure in which the steps are shifted by the height for the number of steps corresponding to the number of the level surfaces, it is possible to ease the tolerance of the oscillation wavelength of the first light source to an individual difference.

Incidentally, in the present specification, a diffractive structure having a characteristic of selectively diffracting a light flux among a plurality of light fluxes different in wavelengths is called as a “wavelength selection diffractive structure.”

Moreover, it is preferable that the first diffractive structure is made of a material having an Abbe number vd on a d-line within a range of from 40 to 80, and wherein a depth of each step of the stepped pattern is equivalent to two times as long as the first wavelength λ₁ in equivalent optical difference, and wherein the number A of the certain level surfaces is four, five or six.

In this manner, by setting the depth of each step of the stepped pattern to be equivalent to two times as long as the first wavelength λ₁ in equivalent optical difference, the wavefronts of the first light flux (e.g. blue) having passed adjoining level surfaces overlap each other in the state of being shifted by two wavelengths. Consequently, the wavefronts can transmit the first diffractive structure without receiving the diffraction function thereof. Moreover, when the first diffractive structure is made of the material having the Abbe number vd on the d-line within the range of from 40 to 80, the optical path difference added to the second light flux (e.g. red) becomes 1.2 times as long as the second wavelength λ₂ by the step. Because the substantial optical path difference obtained by subtracting the optical path difference for one wavelength being equi-phase is 0.2 times as long as the second wavelength λ₂, the optical path difference of the second light flux in a pattern becomes almost one time as long as the second wavelength λ₂ by setting the number A of the level surfaces to any one of four, five and six. In this manner, by arranging the pattern generating the optical path difference almost one time as long as the second wavelength λ₂ periodically, it is possible to diffract the second light flux into the 1^{st} direction at a high diffraction efficiency, and a wavelength selection diffractive structure selectively diffracting only the second light flux can be obtained. At this time, in case of setting the number A of the level surfaces to five, the optical path difference of the second light flux in a patter can be brought closest to the length being one time as long as the second wavelength λ₂ Consequently, the case makes it-possible to secure the transmissivity of the second light flux at the highest level.

Incidentally, in the wavelength selection diffractive structure, the diffraction efficiency of the diffracted light of the second light flux depends on only the Abbe number of the material, but does not depend on the refractive index. Consequently, although the refractive index has a relatively large degree of freedom, the step becomes deeper and it becomes difficult to manufacture the shape of the steps accurately, as the value of the refractive index becomes smaller. Accordingly, when a plurality of materials having the same Abbe number exist, it is preferable to select the material having the largest refractive index.

Moreover, it is preferable that the first diffractive structure provides a divergent operation for the second light flux.

Herewith, the back focal distance of the second light flux (e.g. red) can be extended. Consequently, it becomes possible to make the WD at the time of using the first optical disc (e.g. a high density optical disc) agree with the WD at the time of using the second optical disc (e.g. DVD).

Incidentally, that the second light flux receives the divergent function by the first diffractive structure has the same meaning as that the first diffractive structure has negative diffractive power. The diffractive power φ_{D} of the diffractive structure can be calculated by φ_{D}=−2×dor×λ/λ_{B}×B₂ when the optical path difference added to the incident flux by the diffractive structure is defined by an optical path difference function, which will be described later, where dor denotes a diffraction order, λ denotes the wavelength of an incident flux, λ_{B} denotes a blazed wavelength, and B₂ denotes a second order optical path difference function coefficient.

Moreover, it is preferable that the objective optical system is composed of a diffractive optical element having the optical surface forming the first diffractive structure thereon, and a condenser lens for condensing the first light flux and the second light flux, both having transmitted the diffractive optical element, on information recording surfaces of the first and the second optical discs, respectively, wherein both of the diffractive optical element and the condenser lens are held so as to keep a position for each other.

Herewith, even when the objective optical system is focused or tracked, the optical axes of the diffractive optical element and the condenser lens do not shift from each other, and consequently no aberration is produced. Then, a good focusing characteristic and a good tracking characteristic can be obtained.

Moreover, it is preferable that the optical surface forming the first diffractive structure thereon between the optical surfaces of the diffractive optical element is flat plane of no refractive power for an incident flux.

Herewith, the manufacturing of the first diffractive structure having a stepwise cross section form including an optical axis becomes easy, and it becomes possible to form the first diffractive structure at a high preciseness. Furthermore, the influences of the eclipse of the light flux caused by the steps of each pattern can be reduced. As a result, an objective optical system having a high transmissivity can be obtained.

Moreover, it is preferable that a shape of an optical surface of the condenser lens is designed such that a wavefront aberration of a condensed light spot at a time of condensing the first light flux with the condenser lens through the protective layer having the thickness t₁ is not more than 0.07 λ₁ rms.

This has the same meaning as that the condenser lens is designed for the first light flux (e.g. blue). Herewith, it becomes easy to obtain a sufficient performance of the condenser lens, the manufacturing of which becomes difficult inversely proportional to the wavelength.

Moreover, an optical pick up apparatus is equipped with the objective optical system of claim 1.

Herewith, an optical pickup apparatus having the same effects as those of claim 1 can be obtained.

Moreover, an objective optical system for use in an optical pick up apparatus in which recording and/or reproducing information is conducted for a first optical disc equipped with a protective layer having a thickness t₁ by using a first light flux having a first wavelength λ₁ emitted from a first light source and recording and/or reproducing information is conducted for a second optical disc equipped with a protective layer having a thickness t₂ (t₂≧t₁) by using a second light flux having a second wavelength λ₂ (λ₂>λ₁) and being emitted from a second light source and recording and/or reproducing information is conducted for a third optical disc equipped with a protective layer having a thickness t₃ (t₃>t₂) by using a third light flux having a third wavelength λ₃ (λ₃>λ₂) and being emitted from a third light source, comprises:

a first optical surface forming a first diffractive structure, wherein the first diffractive structure provides a diffractive operation for the second light flux and doesn't provide a diffractive function for the first light flux and the third light flux; and

a second optical surface forming a second diffractive structure, wherein the second optical surface provides a diffractive operation for the third light flux and doesn't provide a diffractive operation for the first light flux and the second light flux,

wherein the objective optical system satisfies at least one formula between the following formulas (1) and (2):
0.9<WD₁/WD₂<1.1 (1)
0.9<WD₁/WD₃<1.1 (2)
where WD₁ represents a first working distance at a time of recording and/or reproducing information for the first optical disc and WD₂ represents a second working distance at a time of recording and/or reproducing information for the second optical disc and WD₃ represents a third working distance at a time of recording and/or reproducing information for the third optical disc.

In this manner, because it becomes possible to independently control the angle of divergence or the angle of convergence of each of the first light flux (e.g. blue), the second light flux (e.g. red) and the third light flux (e.g. infrared) by providing the first diffractive structure selectively diffracting only the second light flux and the second diffractive structure selectively diffracting only the third light flux, it is possible to make the WD's at the time of using at least two kinds of optical discs almost agree with each other (i.e. to make satisfy at least one of the formulae (1) and (2)) without damaging the focusing property of each of the first optical disc (e.g. a high density optical disc), the second optical disc (e.g. a DVD) and the third optical disc (e.g. a CD).

Moreover, it is preferable that the objective optical system satisfies both the following formulas (1) and (2):
0.9<WD₁/WD₂<1.1 ( 1 )
0.9<WD₁/WD₃<1.1 (2)

In this manner, the best form of the objective optical system is to make the WD's at the time of using the first optical disc (e.g. the high density optical disc), the second optical disc (e.g. the DVD) and the third optical disc (e.g. the CD) agree with one another (i.e. to satisfy both of the formulae (1) and (2)).

Moreover, it is preferable that a cross sectional form including an optical axis of the first diffractive structure includes a plurality of stepped patterns which are formed concentrically on the optical surface, wherein each of the stepped patterns is formed by shifting the optical surface by a predetermined height at every number A of certain level surfaces, wherein the predetermined height is equivalent to a height corresponding to the number A of the certain level surfaces.

By adopting such a configuration, it becomes possible to give the first diffractive structure the diffraction characteristics of claim 9.

Moreover, it is preferable that the first diffractive structure is made of a material having an Abbe number on a d-line within a range of from 40 to 80, and wherein a depth of each step of the stepped pattern is equivalent to two times as long as the first wavelength λ₁ in equivalent optical difference, and wherein the number A of the certain level surfaces is four, five or six.

Herewith, a wavelength selection diffractive structure selectively diffracting only the second light flux (e.g. red) can be obtained. By a depth of each step of the stepped pattern is equivalent to two times as long as the first wavelength λ₁ in equivalent optical difference, the wavelength selection diffractive structure can make the first wave flux transmits without being diffracted as it is. Moreover, in the case where the first diffractive structure is made of a material having the Abbe number vd within a range of from 40 to 80 on the d-line, the optical path difference added to the third light flux (e.g. red) by the steps becomes a length one time as long as the third wavelength λ₃. Consequently, the wavefronts of the third light flux passing adjoining level surfaces overlap each other by being shifted by one wavelength, and then also the third light flux can be transmitted without receiving the diffraction function as it is. Moreover, because the principle of generating the diffracted light of the second light flux by the first diffractive structure is the same as that described above, the detailed description thereof is omitted.

Incidentally, in the wavelength selection diffractive structure, in the case where a plurality of materials having the same Abbe number exists, it is preferable to form the wavelength selection diffractive structure with the material having the largest refractive index.

Moreover, it is preferable that the first diffractive structure provides a divergent operation for the second light flux.

Thereby, because the back focal distance of the second light flux (e.g. red) can be extended, it becomes possible to make the WD at the time of using the first optical disc (e.g. a high density optical disc) agree with the WD at the time of using the second optical disc (e.g. DVD).

Moreover, it is preferable that a cross sectional form including an optical axis of the second diffractive structure includes a plurality of stepped patterns which are formed concentrically on the optical surface, wherein each of the stepped patterns is formed by shifting the optical surface by a predetermined height at every number B of certain level surfaces, wherein the predetermined height is equivalent to a height corresponding to the number B of the certain level surfaces.

By adopting such a configuration, it becomes possible to give the diffractive characteristic of claim 9 to the second diffractive structure.

Moreover, it is preferable that the second diffractive structure is made of a material having an Abbe number on a d-line within a range of from 40 to 80, and wherein a depth of each step of the stepped pattern is equivalent to five times as long as the first wavelength λ₁ in equivalent optical difference, and wherein the number B of the certain level surfaces is two.

In this manner, by setting the depth of each step of the stepped pattern to be equivalent to five times as long as the first wavelength λ₁ in equivalent optical path difference, the wavefronts of the first light flux (e.g. blue) having passed adjoining level surfaces overlap each other in the state of being shifted by five wavelengths. Consequently, the wavefronts can transmit the second diffractive structure without receiving the diffraction function thereof. Moreover, when the second diffractive structure is made of the material having the Abbe number vd on the d-line within the range of from 40 to 80, the optical path difference added to the second light flux (e.g. red) becomes three times as long as the second wavelength λ₂ by the step. Consequently, the wavefronts of the second light flux having passed the adjoining level surfaces overlaps each other in the state of being shifted by three wavelengths, and also the second light flux can be transmitted without receiving the diffractive function as it is. On the other hand, the optical path difference added to the third light flux (e.g. infrared) by the step becomes 2.5 times as long as the third wavelength λ₃. Because the substantial optical path difference obtained by subtracting the optical path difference for two wavelengths being equi-phase is 0.5 times as long as the third wavelength λ₃, almost all of the light quantity of the third light flux entering the second diffractive structure is distributed into two pieces of diffractive light of the 1^{st} diffractive light and the −1^{st} diffractive light. By designing the width of each pattern so that the diffractive light of any one of the diffractive orders may condense on the information recording surface of the third optical disc (e.g. a CD), a wavelength selection diffractive structure diffracting only the third light flux selectively can be obtained.

Incidentally, the step becomes deeper and it becomes difficult to manufacture the shape of the steps accurately, as the value of the refractive index becomes smaller. Accordingly, when a plurality of materials having the same Abbe number exist, it is preferable to form the wavelength selection diffractive structure of the invention according to claim 15 by using the material having the largest refractive index.

Moreover it is preferable that the second diffractive structure is made of a material having an Abbe number vd on a d-line within a range of from 20 to 40, and wherein a depth of each step of the stepped pattern is equivalent to seven times as long as the first wavelength λ₁ in equivalent optical difference, and wherein the number B of the certain level surfaces is three or four.

In this manner, by setting the depth of each step of the stepped pattern to be equivalent to seven times as long as the first wavelength λ₁ in equivalent optical path difference, the wavefronts of the first light flux (e.g. blue) having passed adjoining level surfaces overlap each other in the state of being shifted by seven wavelengths. Consequently, the wavefronts can transmit the second diffractive structure without receiving the diffraction function thereof as it is. Moreover, when the second diffractive structure is made of the material having the Abbe number vd on the d-line within the range of from 40 to 80, the optical path difference added to the second light flux (e.g. red) becomes four times as long as the second wavelength λ₂ by the step. Consequently, the wavefronts of the second light flux having passed the adjoining level surfaces overlaps each other in the state of being shifted by four wavelengths, and also the second light flux can be transmitted without receiving the diffractive function as it is. On the other hand, the optical path difference added to the third light flux (e.g. infrared) by the step becomes 1.5 times to 1.3 times as long as the third wavelength λ₃. Because the substantial optical path difference obtained by subtracting the optical path difference for one wavelength being equi-phase is 0.25 time to 0.3 time as long as the third wavelength λ₃, the optical path difference of the third light flux in a pattern becomes almost one time as long as the third wavelength λ₃ when the number A of the level surfaces is set to either three or four. In this manner, by arranging patterns generating the optical path difference almost one time as long as the third wavelength λ₃ periodically, the third light flux can be diffracted into the 1^{st} direction at a high diffraction efficiency, and a wavelength selection diffractive structure diffracting only the third light flux selectively can be obtained.

Incidentally, when there is a plurality of materials having the same Abbe number in the wavelength selection diffractive structure, it is preferable to form the wavelength selection diffractive structure using the material having the largest refractive index.

Moreover, it is preferable that the second diffractive structure is formed on a joint surface of a material having an Abbe number vd on a d-line within a range of from 20 to 40 and a refractive index nd on the d-line within a range of from 1.55 to 1.70, and a material having an Abbe number vd on a d-line within a range of from 45 to 65 and a refractive index nd on the d-line within a range of from 1.45 to 1.55, wherein a depth of each step of the stepped pattern is equivalent to two times as long as the first wavelength λ₁ in equivalent optical difference, and wherein the number B of the certain level surfaces is four, five or six.

In this manner, by setting the depth of each step of the stepped pattern to be equivalent to two times as long as the first wavelength λ₁ in equivalent optical path difference, the wavefronts of the first light flux (e.g. blue) having passed adjoining level surfaces overlap each other in the state of being shifted by two wavelengths. Consequently, the wavefronts can transmit the second diffractive structure without receiving the diffraction function thereof as it is. Moreover, when the second diffractive structure is formed on the joint surface of two materials as described in claim 17, the optical path difference added to the second light flux (e.g. red) by the step becomes one time as long as the second wavelength λ₂ Consequently, the wavefronts of the second light flux having passed adjoining level surfaces overlap each other in the state of being shifted by one wavelength, and also the second light flux can be transmitted without receiving the diffractive function as it is. On the other hand, the optical path difference added to the third light flux (e.g. infrared) by the step becomes 0.75 time to 0.8 time as long as the third wavelength λ₃. Because the substantial optical path difference obtained by subtracting the optical path difference for one wavelength being equi-phase is 0.2 time to 0.25 time as long as the third wavelength λ₃, the optical path difference of the third light flux in a pattern becomes almost one time as long as the third wavelength λ₃ when the number A of the level surfaces is set to any one of four, five and six. In this manner, by arranging patterns generating the optical path difference almost one time as long as the third wavelength λ₃ periodically, the third light flux can be diffracted into the 1^{st} direction at a high diffraction efficiency, and a wavelength selection diffractive structure diffracting only the third light flux selectively can be obtained.

Moreover, it is preferable that the second diffractive structure provides a divergent operation for the third light flux.

Herewith, the back focal distance of the third light flux (e.g. red) can be extended. Consequently, it becomes possible that the WD at the time of using the first optical disc (e.g. a high density optical disc) and the WD at the time of using the third optical disc (e.g. a CD) can be made to agree with each other.

Moreover, it is preferable that the objective optical system comprises:

a diffractive optical element having at least one of the optical surface forming the first diffractive structure thereon and the optical surface forming the second diffractive structure thereon, and a condenser lens for condensing the first light flux to the third light flux, all having transmitted the diffractive optical element, on information recording surfaces of the first to the third optical discs, respectively,

wherein both of the diffractive optical element and the condenser lens are held so as to keep a position for each other.

The operations and effects at this time are the same as those of the invention described in claim 5.

Moreover, it is preferable that the optical surface forming the first diffractive structure and/or the second diffractive surface thereon between the optical surfaces of the diffractive optical element is flat plane of no refractive power for an incident flux.

The operations and the effects at this time are the same as those of the invention described in claim 6.

Moreover, it is preferable that a shape of an optical surface of the condenser lens is designed such that a wavefront aberration of a condensed light spot at a time of condensing the first light flux with the condenser lens through the protective layer having the thickness t₁ is not more than 0.07 λ₁ rms.

The operations and effects at this time is the same as those of the invention described in claim 7.

Moreover, an optical pick up apparatus equipped with the objective optical system of claim 9.

Herewith, an optical pick up apparatus having the same effects as those of claim 9 can be obtained.

For example, the optical pick up apparatus performs recording and/or reproducing information for a first optical disc equipped with a protective layer having a thickness t₁ by using a first light flux having a first wavelength λ₁ (350 nm≦λ₁, ≦450 nm) emitted from a first light source, recording and/or reproducing information for a second optical disc equipped with a protective layer having a thickness t₂(t₂≧t₁) by using a second light flux having a second wavelength λ₂ (λ₂>λ₁) emitted from a second light source, and recording and/or reproducing information for a third optical disc equipped with a protective layer having a thickness t₃ (t₃>t₂) by using a third light flux having a third wavelength λ₃ (λ₃>λ₂) emitted from a third light source, and comprises:

an objective optical system including a diffractive optical element having a first diffractive structure, wherein the first diffractive structure provides a diffractive operation for the second light flux and doesn't provide a diffractive operation for the first light flux and the third light flux, and a light converging element for converging the first to the third light fluxes having transmitted the diffractive optical device on information recording surfaces of the first to the third optical discs, respectively, wherein the objective optical system satisfies the following formula (1):
0.9<WD₁/WD₂<1.1 (1)
where WD₁ represents a first working distance at a time of recording and/or reproducing information for the first optical disc and WD₂ represents a second working distance at a time of recording and/or reproducing information for the second optical disc.

Moreover, for example, the optical pick up apparatus performs recording and/or reproducing information for a first optical disc equipped with a protective layer having a thickness t₁ by using a first light flux having a first wavelength λ₁ (350 nm≦λ₁≦450 nm) emitted from a first light source, recording and/or reproducing information for a second optical disc equipped with a protective layer having a thickness t₂(t₂≧t₁) by using a second light flux having a second wavelength λ₂ (λ₂>λ₁) and being emitted from a second light source, and recording and/or reproducing information for a third optical disc equipped with a protective layer having a thickness t₃ (t₃>t₂) by using a third light flux having a third wavelength λ₃ (λ₃>λ₂) and being emitted from a third light source, and comprises:

an objective optical system including a diffractive optical element having a second diffractive structure, wherein the second diffractive structure provides a diffractive operation for the third light flux and doesn't provide a diffractive operation for the first light flux and the second light flux, and a light converging element for converging the first to the third light fluxes having transmitted the diffractive optical device on information recording surfaces of the first to the third optical discs, respectively,

wherein the objective optical system satisfies the following formula (2):
0.9<WD₁/WD₃<1.1 (2)
where WD₁ represents a first working distance at a time of recording and/or reproducing information for the first optical disc and WD₃ represents a third working distance at a time of recording and/or reproducing information for the third optical disc.

Moreover, for example, the optical pick up apparatus performs recording and/or reproducing information for a first optical disc equipped with a protective layer having a thickness t₁ by using a first light flux having a first wavelength λ₁ (350 nm≦λ₁≦450 nm) emitted from a first light source, recording and/or reproducing information for a second optical disc equipped with a protective layer having a thickness t₂(t₂≧t₁) by using a second light flux having a second wavelength λ₂ (λ₂>λ₁) and being emitted from a second light source, and recording and/or reproducing information for a third optical disc equipped with a protective layer having a thickness t₃ (t₃>t₂) by using a third light flux having a third wavelength λ₃ (λ₃>λ₂) and being emitted from a third light source, and comprises:

an objective optical system including a diffractive optical element having a first diffractive structure and a second diffractive structure, wherein the first diffractive structure provides a diffractive operation for the second light flux and doesn't provide a diffractive operation for the first light flux and the third light flux and wherein the second diffractive structure provides a diffractive operation for the third light flux and doesn't provide a diffractive operation for the first light flux and the second light flux, and a light converging element for converging the first to the third light fluxes having transmitted the diffractive optical device on information recording surfaces of the first to the third optical discs, respectively,

wherein the objective optical system satisfies both of the following formulae (1) and (2):
0.9<WD₁/WD₂<1.1 (1)
0.9<WD₁/WD₃<1.1 (2)
where WD₁ represents a first working distance at a time of recording and/or reproducing information for the first optical disc and WD₂ represents a second working distance at a time of recording and/or reproducing information for the second optical disc and WD₃ represents a third working distance at a time of recording and/or reproducing information for the third optical disc.

According to the above, by the operations of the first diffractive structure and the second diffractive structure, which are wavelength selection diffractive structures, it is possible to selectively adjust the WD's at the time of using a plurality of kinds of optical discs having different thicknesses of substrates, in particular at least two kinds of optical discs including a high density optical disc such as at the time of using the high density optical disc and at the time of using a CD, and to make them agree with each other. Herewith, it is needless to drive an actuator according to the kind of an optical disc to adjust an initial position of the objective optical system. As a result, it is possible to make an objective optical system and an optical pick up equipped with the objective optical system which can suppress the power consumption thereof and make the actuator thereof be miniaturized.

Incidentally, the present invention is not limited to the embodiments described above, but various improvements and alterations of the design thereof may be performed without departing from the scope and sprit of the present invention.

The entire disclosure of Japanese Patent Application No. Tokugan 2004-318319 filed on Nov, 1, 2004 including specification, claims, drawings and summary are incorporated herein by reference in its entirety.

What is claimed is:

1. An objective optical system for use in an optical pick up apparatus in which recording and/or reproducing information is conducted for a first optical disc equipped with a protective layer having a thickness t₁ by using a first light flux having a first wavelength λ₁ emitted from a first light source and recording and/or reproducing information is conducted for a second optical disc equipped with a protective layer having thickness t₂ (t₂>t₁) by using a second light flux having a second wavelength λ₂ (λ₂>λ₁) emitted from a second light source, comprising:
an optical surface forming a first diffractive structure, wherein the first diffractive structure provides a diffractive operation for the second light flux and doesn't provide a diffractive operation for the first light flux,
wherein the objective optical system satisfies the following formula (1):
0.9<WD₁/WD₂<1.1 (1)
where WD₁ represents a first working distance in recording and/or reproducing the information for the first optical disc and WD₂ represents a second working distance in recording and/or reproducing the information for the second optical disc.

2. The objective optical system of claim 1, wherein a cross sectional form including an optical axis of the first diffractive structure includes a plurality of stepped patterns which are formed concentrically on the optical surface, wherein each of the stepped patterns is formed by shifting the optical surface by a predetermined height at every number A of certain level surface, wherein the predetermined height is equivalent to a height corresponding to the number A of the certain level surfaces.

3. The objective optical system of claim 2, wherein the first diffractive structure is made of a material having an Abbe number vd on a d-line within a range of from 40 to 80, and wherein a depth of each step of the stepped pattern is equivalent to two times as long as the first wavelength λ₁ in equivalent optical difference, and wherein the number A of the certain level surfaces is four, five or six.

4. The objective optical system of claim 1, wherein the first diffractive structure provides a divergent operation for the second light flux.

5. The objective optical system of claim 1, comprising:
a diffractive optical element having the optical surface forming the first diffractive structure thereon, and
a light converging element for converging the first light flux and the second light flux, both having transmitted the diffractive optical element, on information recording surfaces of the first and the second optical discs, respectively,
wherein both of the diffractive optical element and the light converging element are held so as to keep a position for each other.

6. The objective optical system of claim 5, wherein the optical surface forming the first diffractive structure thereon is flat plane of no refractive power for an incident flux.

7. The objective optical system of claim 5, wherein a shape of an optical surface of the light converging element is designed such that a wavefront aberration of a light spot at a time of converging the first light flux with the light converging element through the protective layer having the thickness t₁ is not more than 0.07 λ₁ rms.

8. An optical pick up apparatus equipped with the objective optical system of claim 1.

9. An objective optical system for use in an optical pick up apparatus in which recording and/or reproducing information is conducted for a first optical disc equipped with a protective layer having a thickness t₁ by using a first light flux having a first wavelength λ₁ emitted from a first light source and recording and/or reproducing information is conducted for a second optical disc equipped with a protective layer having a thickness t₂ (t₂>t₁) by using a second light flux having a second wavelength λ₂ (λ₂>λ₂) and being emitted from a second light source and recording and/or reproducing information is conducted for a third optical disc equipped with a protective layer having a thickness t₃ (t₃>t₂) by using a third light flux having a third wavelength λ₃ (λ₃>λ₂) and being emitted from a third light source, comprising:
a first optical surface forming a first diffractive structure, wherein the first diffractive structure provides a diffractive operation for the second light flux and doesn't provide a diffractive function for the first light flux and the third light flux; and
a second optical surface forming a second diffractive structure, wherein the second optical surface provides a diffractive operation for the third light flux and doesn't provide a diffractive operation for the first light flux and the second light flux,
wherein the objective optical system satisfies at least one formula between the following formulas (1) and (2):
0.9<WD₁/WD₂<1.1 (1)
0.9<WD₁/WD₃<1.1 (2)
where WD₁ represents a first working distance at a time of recording and/or reproducing information for the first optical disc and WD₂ represents a second working distance at a time of recording and/or reproducing information for the second optical disc and WD₃ represents a third working distance at a time of recording and/or reproducing information for the third optical disc.

10. The objective optical system of claim 9, wherein the objective optical system satisfies both the following formulas (1) and (2):
0.9<WD₁/WD₂<1.1 (1)
0.9<WD₁/WD₃<1.1 (2)

11. The objective optical system of claim 9, wherein a cross sectional form including an optical axis of the first diffractive structure includes a plurality of stepped patterns which are formed concentrically on the optical surface, wherein each of the stepped patterns is formed by shifting the optical surface by a predetermined height at every number A of certain level surface, wherein the predetermined height is equivalent to a height corresponding to the number A of the certain level surfaces.

12. The objective optical system of claim 11, wherein the first diffractive structure is made of a material having an Abbe number vd on a d-line within a range of from 40 to 80, and wherein a depth of each step of the stepped pattern is equivalent to two times as long as the first wavelength λ₁ in equivalent optical difference, and wherein the number A of the certain level surfaces is four, five or six.

13. The objective optical system of claim 9, wherein the first diffractive structure provides a divergent operation for the second light flux.

14. The objective optical system of claim 9, wherein a cross sectional form including an optical axis of the second diffractive structure includes a plurality of stepped patterns which are formed concentrically on the optical surface, wherein each of the stepped patterns is formed by shifting the optical surface by a predetermined height at every number B of certain level surfaces, wherein the predetermined height is equivalent to a height corresponding to the number B of the certain level surfaces.

15. The objective optical system of claim 14, wherein the second diffractive structure is made of a material having an Abbe number vd on a d-line within a range of from 40 to 80, and wherein a depth of each step of the stepped pattern is equivalent to five times as long as the first wavelength λ₁ in equivalent optical difference, and wherein the number B of the certain level surfaces is two.

16. The objective optical system of claim 14, wherein the second diffractive structure is made of a material having an Abbe number vd on a d-line within a range of from 20 to 40, and wherein a depth of each step of the stepped pattern is equivalent to seven times as long as the first wavelength λ₁ in equivalent optical difference, and wherein the number B of the certain level surfaces is three or four.

17. The objective optical system of claim 14, wherein the second diffractive structure is formed on a joint surface of a material having an Abbe number vd on a d-line within a range of from 20 to 40 and a refractive index nd on the d-line within a range of from 1.55 to 1.70, and a material having an Abbe number vd on a d-line within a range of from 45 to 65 and a refractive index nd on the d-line within a range of from 1.45 to 1.55, wherein a depth of each step of the stepped pattern is equivalent to two times as long as the first wavelength λ₁ in equivalent optical difference, and wherein the number B of the certain level surfaces is four, five or six.

18. The objective optical system of claim 9, wherein the second diffractive structure provides a divergent operation for the third light flux.

19. The objective optical system of claim 9, comprising:
a diffractive optical element having at least one of the optical surface forming the first diffractive structure thereon and the optical surface forming the second diffractive structure thereon, and
a light converging element for converging the first light flux to the third light flux, all having transmitted the diffractive optical element, on information recording surfaces of the first to the third optical discs, respectively,
wherein both of the diffractive optical element and the light converging element are held so as to keep a position for each other.

20. The objective optical system of claim 19, wherein the optical surface having at least one of the first diffractive structure and the second diffractive structure is flat plane of no refractive power for an incident flux.

21. The objective optical system of claim 19, wherein a shape of an optical surface of the light converging element is designed such that a wavefront aberration of a light spot at a time of converging the first light flux with the light converging element through the protective layer having the thickness t₁ is not more than 0.07 λ₁ rms.

22. An optical pick up apparatus equipped with the objective optical system of claim 9.

23. The objective optical system of claim 1, wherein the first wavelength λ₁ of the first light flux satisfies the following formula (3) and the protective layer thickness t₁ of the first optical disc satisfies the following formula (4),
350 nm 23 λ₁≦450 nm (3)
0.1 mm≦t₁≦0.7 mm (4).

24. The objective optical system of claim 23, wherein the second wavelength 2 of the second light flux satisfies the following formula (5) and the protective layer thickness t₂ of the second optical disc satisfies the following formula (6),
600 nm≦λ₂≦700 nm (5)
0.5 mm≦t₂≦0.7 mm (6).

25. The objective optical system of claim 9, wherein the first wavelength λ₁ of the first light flux satisfies the following formula (3) and the protective layer thickness t₁ of the first optical disc satisfies the following formula (4),
350 nm≦λ₁≦450 nm (3)
0.1 mm≦t₁≦0.7 mm (4).

26. The objective optical system of claim 25, wherein the second wavelength 2 of the second light flux satisfies the following formula (5) and the protective layer thickness t₂ of the second optical disc satisfies the following formula (6),
600 nm≦λ₂≦700 nm (5)
0.5 mm≦t₂≦0.7 mm (6).

27. The objective optical system of claim 25, wherein the third wavelength λ₃ of the third light flux satisfies the following formula (7) and the protective layer thickness t₃ of the third optical disc satisfies the following formula (8),
750 nm≦λ₃≦850 nm (7)
0.9 mm≦t₃≦1.3 mm (8).

28. An optical pick up apparatus in which recording and/or reproducing information is conducted for a first optical disc equipped with a protective layer having a thickness t₁ by using a first light flux having a first wavelength λ₁ (350 nm≦λ₁≦450 nm) emitted from a first light source and recording and/or reproducing information is conducted for a second optical disc equipped with a protective layer having a thickness t₂(t₂≧t₁) by using a second light flux having a second wavelength λ₂ (λ₂>λ₁) emitted from a second light source and recording and/or reproducing information is conducted for a third optical disc equipped with a protective layer having a thickness t₃ (t₃>t₂) by using a third light flux having a third wavelength λ₂₃ (λ₃>λ₂) emitted from a third light source, comprising:
an objective optical system including a diffractive optical element having a first diffractive structure, wherein the first diffractive structure provides a diffractive operation for the second light flux and doesn't provide a diffractive operation for the first light flux and the third light flux, and a light converging element for converging the first to the third light fluxes having transmitted the diffractive optical device on information recording surfaces of the first to the third optical discs, respectively,
wherein the objective optical system satisfies the following formula (1):
0.9<WD₁/WD₂<1.1 (1)
where WD₁ represents a first working distance at a time of recording and/or reproducing information for the first optical disc and WD₂ represents a second working distance at a time of recording and/or reproducing information for the second optical disc.

29. An optical pick up apparatus in which recording and/or reproducing information is conducted for a first optical disc equipped with a protective layer having a thickness t₁ by using a first light flux having a first wavelength λ₁ (350 nm≦λ₁≦450 nm) emitted from a first light source and recording and/or reproducing information is conducted for a second optical disc equipped with a protective layer having a thickness t₂(t₂≧t₁) by using a second light flux having a second wavelength λ₂ (λ₂>λ₁) and being emitted from a second light source and recording and/or reproducing information is conducted for a third optical disc equipped with a protective layer having a thickness t₃ (t₃>t₂) by using a third light flux having a third wavelength λ₃ (λ₃>λ₂) and being emitted from a third light source, comprising:
an objective optical system including a diffractive optical element having a second diffractive structure, wherein the second diffractive structure provides a diffractive operation for the third light flux and doesn't provide a diffractive operation for the first light flux and the second light flux, and a light converging element for converging the first to the third light fluxes having transmitted the diffractive optical device on information recording surfaces of the first to the third optical discs, respectively,
wherein the objective optical system satisfies the following formula (2):
0.9<WD₁/WD₃<1.1 (2)
where WD₁ represents a first working distance at a time of recording and/or reproducing information for the first optical disc and WD₃ represents a third working distance at a time of recording and/or reproducing information for the third optical disc.

30. An optical pick up apparatus in which recording and/or reproducing information is conducted for a first optical disc equipped with a protective layer having a thickness t₁ by using a first light flux having a first wavelength λ₁ (350 nm≦λ₁≦450 nm) emitted from a first light source and recording and/or reproducing information is conducted for a second optical disc equipped with a protective layer having a thickness t₂(t₂≧t₁) by using a second light flux having a second wavelength λ₂ (λ₂>λ₁) and being emitted from a second light source and recording and/or reproducing information is conducted for a third optical disc equipped with a protective layer having a thickness t₃ (t₃>t₂) by using a third light flux having a third wavelength λ₃ (λ₃>λ₂) and being emitted from a third light source, comprising:
an objective optical system including a diffractive optical element having a first diffractive structure and a second diffractive structure, wherein the first diffractive structure provides a diffractive operation for the second light flux and doesn't provide a diffractive operation for the first light flux and the third light flux and wherein the second diffractive structure provides a diffractive operation for the third light flux and doesn't provide a diffractive operation for the first light flux and the second light flux, and
a light converging element for converging the first to the third light fluxes having transmitted the diffractive optical device on information recording surfaces of the first to the third optical discs, respectively,
wherein the objective optical system satisfies both of the following formulae (1) and (2):
0.9<WD₁/WD₂<1.1 (1)
0.9<WD₁/WD₃<1.1 (2)
where WD₁ represents a first working distance at a time of recording and/or reproducing information for the first optical disc and WD₂ represents a second working distance at a time of recording and/or reproducing information for the second optical disc and WD₃ represents a third working distance at a time of recording and/or reproducing information for the third optical disc.
